(19) United States
(12) Patent Application Publication
(10) Pub. No.: US 2026/0146964 A1
(43) Pub. Date: May 28, 2026

(54) Logger And Method For Attaching Logger

(71) Applicant: SEIKO EPSON CORPORATION, Tokyo (JP)

(72) Inventors: Ryuta NISHIZAWA, Nagano (JP); Toshiya USUDA, Ina (JP); Taichi FUJINAMI, Minowa (JP)

(21) Appl. No.: 19/395,339

(22) Filed: Nov. 20, 2025

(30) Foreign Application Priority Data
Nov. 22, 2024 (JP) 2024-203578

(51) Int. Cl. G01N 27/04; G01D 9/00

(52) U.S. Cl. CPC G01N 27/048; G01D 9/005

(57) ABSTRACT

A logger includes a clock circuit configured to generate time information, a first electrode, a second electrode to which a reference voltage is supplied, an event detection circuit configured to detect an event based on a voltage change in an input signal input from the first electrode, a storage circuit, and a processing circuit. When the event is detected by the event detection circuit, the processing circuit determines that the resistance value of the measurement object disposed between the first electrode and the second electrode has changed due to wetting of the measurement object by a liquid, and records, in the storage circuit as log information, time information indicating detection of the event.

The present application is based on, and claims priority from JP Application Serial Number 2024-203578, filed Nov. 22, 2024, the disclosure of which is hereby incorporated by reference herein in its entirety.

### BACKGROUND

### 1. Technical Field

The present disclosure relates to a logger, and a method for attaching a logger.

### 2. Related Art

JP-A-2000-283938 discloses a dewpoint sensor that, when exposed to a flow between the entry port and the exit port of a pressure vessel, calculates a dewpoint value of that flow. A quartz crystal resonator is housed within the pressure vessel, a circuit controls the temperature of the quartz crystal resonator, and a temperature sensor generates signals representing the temperature of the quartz crystal resonator. The circuit monitors the temperature signals and the frequency of the quartz crystal resonator and calculates the dewpoint value.

The dewpoint sensor disclosed in JP-A-2000-283938 is very large in scale and difficult to miniaturize. This dewpoint sensor is intended to calculate a dewpoint value and is not a logger for recording times and measured values in association with each other.

### SUMMARY

An aspect of the present disclosure relates to a logger including a clock circuit configured to generate time information; a first electrode; a second electrode to which a reference voltage is supplied; an event detection circuit configured to detect an event based on a voltage change of an input signal input from the first electrode; a storage circuit; and a processing circuit configured to determine, in response to detection of the event by the event detection circuit, a change in a resistance value of the measurement object disposed between the first electrode and the second electrode due to wetting of the measurement object by a liquid, and to record, in the storage circuit as log information, the time information indicating detection of the event.

Another aspect of the present disclosure relates to a method for attaching a logger to a measurement object, the logger including: a clock circuit configured to generate time information, a first electrode, a second electrode to which a reference voltage is supplied, an event detection circuit configured to detect an event based on an input signal input from the first electrode, a storage circuit, and a processing circuit configured to record the time information in the storage circuit when the event detection circuit detects the event, the method comprising: attaching the logger to the measurement object such that the first electrode and the second electrode of the logger are in contact with the measurement object.

### BRIEF DESCRIPTION OF THE DRAWINGS

FIG. 1 is a block diagram illustrating a configuration example of a logger.

FIG. 2 illustrates operation of the logger.

FIG. 3 is an external perspective view of a real-time clock device.

FIG. 4 illustrates a first structural example of the logger.

FIG. 5 is a block diagram illustrating a first circuit configuration example of the real-time clock device.

FIG. 6 is a block diagram illustrating a detailed configuration example of an event detection circuit.

FIG. 7 is a block diagram illustrating a detailed configuration example of a processing circuit.

FIG. 8 illustrates a first structural example of the real-time clock device.

FIG. 9 illustrates a second structural example of the logger.

FIG. 10 illustrates a third structural example of the logger.

FIG. 11 illustrates a fourth structural example of the logger.

FIG. 12 illustrates a fifth structural example of the logger.

FIG. 13 depicts a second shape example of a first electrode and a second electrode.

FIG. 14 depicts a third shape example of the first electrode and the second electrode.

FIG. 15 is a block diagram illustrating a second circuit configuration example of the real-time clock device.

FIG. 16 is a block diagram illustrating a detailed configuration example of a sensor and a detection circuit.

FIG. 17 illustrates a second structural example of the real-time clock device.

FIG. 18 illustrates the second structural example of the real-time clock device.

### DESCRIPTION OF EMBODIMENTS

An embodiment of the present disclosure will now be described in detail. The present embodiment described below does not unduly limit the scope of the appended claims, and not all the configurations described in the present embodiment are necessarily essential constituent elements.

### 1. Configuration Example

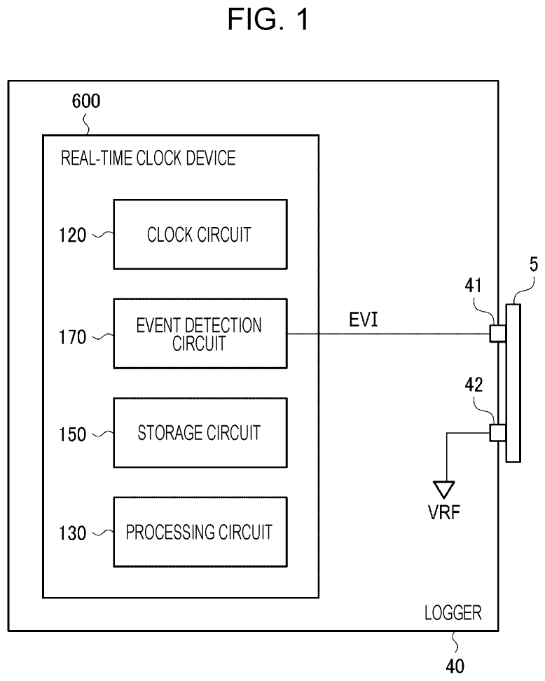

FIG. 1 is a block diagram illustrating a configuration example of a logger 40 according to the present embodiment. The logger 40 includes a real-time clock device 600, a first electrode 41, and a second electrode 42. The real-time clock device 600 includes a clock circuit 120, an event detection circuit 170, a storage circuit 150, and a processing circuit 130.

Hereafter, an example will be described in which the real-time clock device 600 is used as the sensor module of the logger 40. That is, in this example, the event timestamp function of a real-time clock (RTC) is used as a log recording function. However, the sensor module of the logger 40 is not limited thereto, and may be any sensor module as long as it includes the clock circuit 120, the event detection circuit 170, the storage circuit 150, and the processing circuit 130 described below.

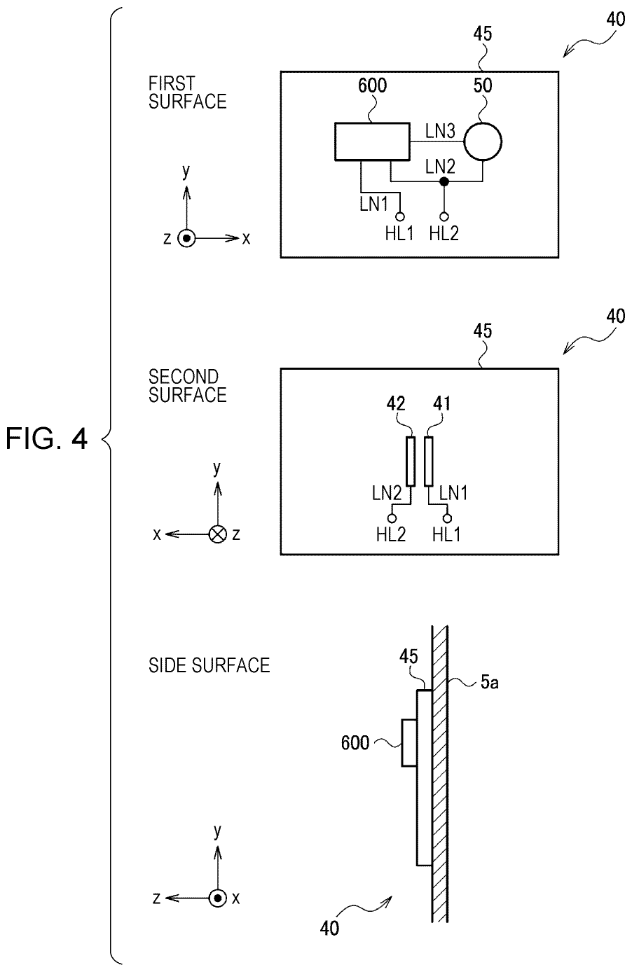

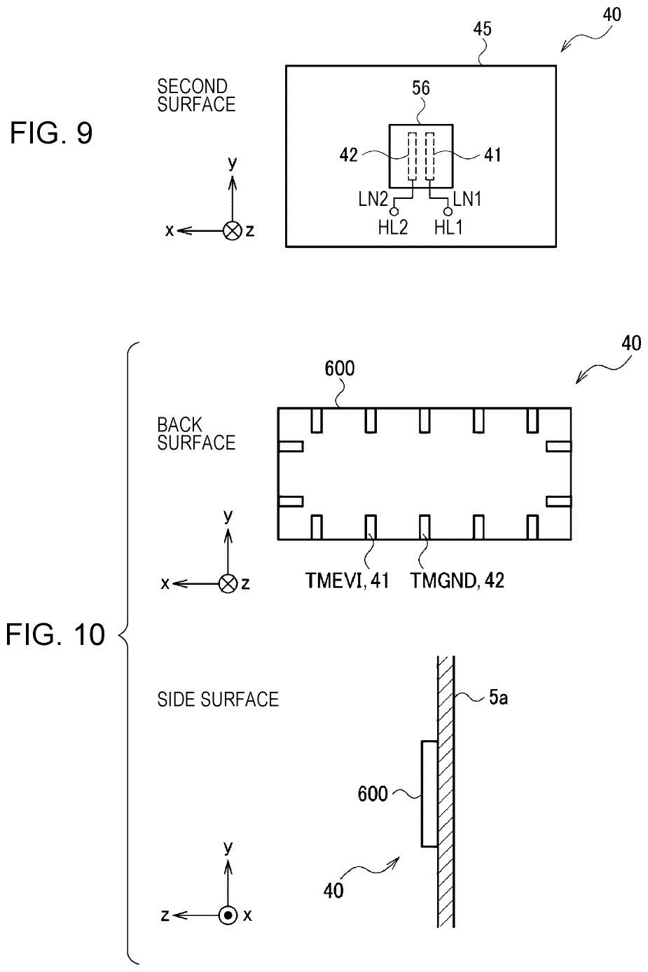

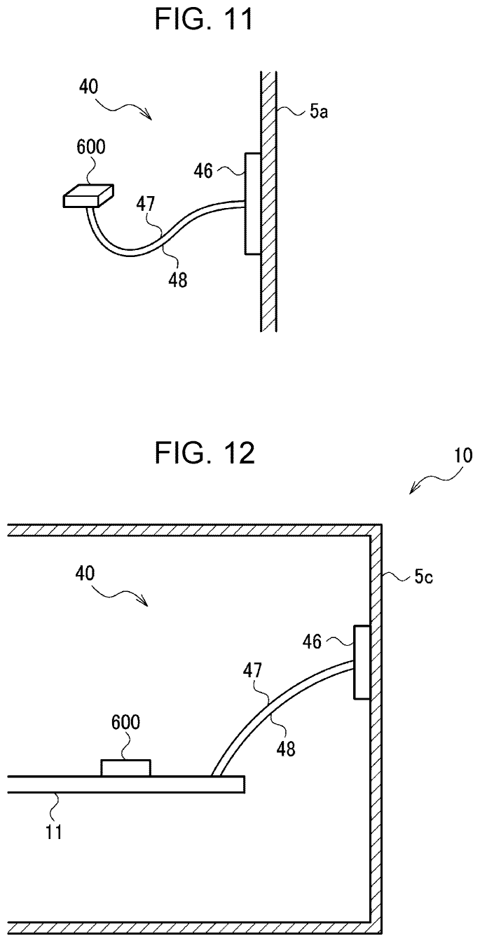

When the logger 40 is used, it is attached to a measurement object 5. At this time, the first electrode 41 and the second electrode 42 are in contact with the measurement object 5. An example of the measurement object 5 in this case is corrugated fiberboard 5a described with reference to FIG. 4. Alternatively, the logger 40 may include the measurement object 5 in advance, with the first electrode 41 and the second electrode 42 in contact with the measurement object 5. An example of the measurement object 5 in this case is a piece of paper 56 described with reference to FIG. 9. Alternatively, the first electrode 41 and the second electrode 42 may be disposed on the measurement object 5, and the logger 40 may include the measurement object 5. Examples of the measurement object 5 in this case are a substrate 45 in FIG. 4, a substrate 46 in FIG. 11, or the substrate 46 in FIG. 12. The first and second electrodes 41 and 42 may also be used while exposed to the air instead of being in contact with the corrugated fiberboard 5a or the like.

The measurement object 5 is not limited to the above examples, and may be any substance as long as the resistance value between the first electrode 41 and the second electrode 42 changes when the substance is wetted by a liquid. For example, the measurement object 5 is wetted when a liquid soaks into it, when it absorbs a liquid, or when a liquid adheres to its surface. The measurement object 5 may be any substance, and is, for example, paper, wood, resin, insulating coated metal, ceramic, or glass. The liquid may be any liquid as long as it can change the resistance value of the measurement object 5, and is, for example, water. Examples of situations in which the measurement object 5 is wetted by a liquid include condensation of moisture in the air, wetting by rain, submersion in water, and liquid leakage from a container or the like. Although wetting due to condensation will be described hereafter as an example, “condensation” may be replaced with various wetting situations as mentioned above.

A reference voltage VRF is supplied to the second electrode 42. The reference voltage VRF may be any constant voltage, for example, a power supply voltage or a ground voltage of the real-time clock device 600. For example, the logger 40 may include a power supply such as a battery, and a power supply voltage or a ground voltage generated by the power supply may be used as the reference voltage VRF. The power supply may be disposed inside or outside the real-time clock device 600.

The first electrode 41 is connected to the second electrode 42 of the reference voltage VRF through a resistance caused by the measurement object 5. The event detection circuit 170 monitors an input signal EVI from the first electrode 41 to detect the resistance value of the measurement object 5, that is, the state of condensation, as an event. The state of condensation may be represented by a binary value indicating whether condensation is present or absent, or may be represented by multiple values indicating the degree of condensation in multiple stages. The state in which there is no condensation may include not only a state in which condensation has never occurred but also a dry state after condensation. Hereafter, a technique using resistance voltage division will be described as an example of a technique that changes the input signal EVI in accordance with the resistance value of the measurement object 5.

The first electrode 41 is pulled up or down to a voltage different from the reference voltage VRF. For example, when the reference voltage VRF is the ground voltage, the first electrode 41 is pulled up to the power supply voltage. A pull-up resistor or a pull-down resistor may be built into the event detection circuit 170 or may be provided outside the real-time clock device 600. The voltage of the input signal EVI changes in accordance with the resistance ratio between the resistance of the pull-up or pull-down resistor connected to the first electrode 41 and the resistance of the measurement object 5. The event detection circuit 170 detects a condensation event based on this voltage change.

The clock circuit 120 generates time information TMD indicating the current point in time. An example of the time information TMD is so-called calendar data. The calendar data represents some or all of the following: year, month, day, hour, minute, and second.

When a condensation event is detected by the event detection circuit 170, the processing circuit 130 acquires the time information TMD from the clock circuit 120, and records log information of condensation in the storage circuit 150 based on the time information TMD. The log information is information in which the occurrence of a condensation event is associated with the time information TMD at which the event has occurred. As described above, the logger 40 can record log information of condensation by monitoring a resistance value change of the measurement object 5 caused by condensation. This enables the logger 40 to achieve, for example, a simple configuration for miniaturization, low power consumption, and low cost.

Although FIG. 1 illustrates an example in which the first electrode 41 is disposed separately from the real-time clock device 600, a terminal of the real-time clock device 600 may be used as the first electrode 41, as described later. The same applies to the second electrode 42. When the first electrode 41 and the second electrode 42 are the terminals of the real-time clock device 600, the real-time clock device 600 itself functions as the logger 40.

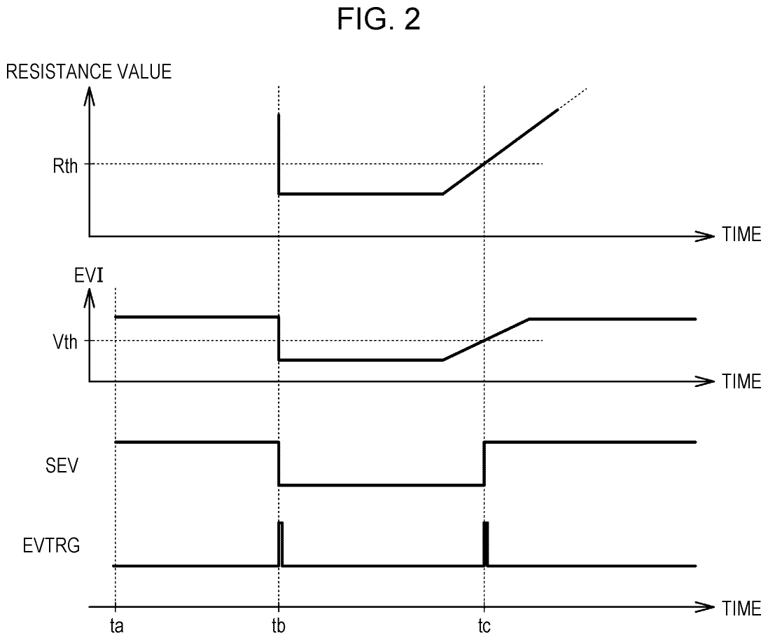

FIG. 2 illustrates operation of the logger 40. Illustrated here is an example in which the ground voltage is supplied to the second electrode 42, the first electrode 41 is pulled up to the power supply voltage, and the presence or absence of condensation is detected.

At time ta, the real-time clock device 600 is activated and initialized. The initialization includes initial setting of the time information TMD, operation setting of the timestamp, and so forth. At time ta, it is assumed that no condensation has occurred and the measurement object 5 is not wet. Since the measurement object 5 between the first electrode 41 and the second electrode 42 has a high resistance, the input signal EVI is pulled up close to the power supply voltage.

At time tb, it is assumed that condensation has occurred and the measurement object 5 is wetted. The resistance of the measurement object 5 between the first electrode 41 and the second electrode 42 decreases, and therefore the input signal EVI is close to the ground voltage due to the ground voltage of the second electrode 42. The event detection circuit 170 compares the voltage of the input signal EVI with the threshold voltage Vth to generate an event detection signal SEV. The threshold voltage Vth is a constant voltage between the power supply voltage and the ground voltage. Assuming that a resistance corresponding to the threshold voltage Vth is a threshold Rth, the above comparison may be rephrased as a comparison of the resistance of the measurement object 5 between the first electrode 41 and the second electrode 42 with the resistance threshold Rth. The event detection signal SEV is at a first logic level when the input signal EVI is equal to or higher than the threshold voltage Vth, and is at a second logic level when the input signal EVI is lower than the threshold voltage Vth. FIG. 2 illustrates an example in which the first logic level is a high level and the second logic level is a low level. At time tb, the event detection signal SEV changes from the high level to the low level.

When the condensation stops, the measurement object 5 becomes dry. It is assumed that, at time tc, the resistance of the measurement object 5 between the first electrode 41 and the second electrode 42 is equal to or higher than the threshold Rth. At time tc, the input signal EVI becomes equal to or higher than the threshold voltage Vth, and therefore the event detection signal SEV changes from the low level to the high level.

In accordance with the event detection signal SEV, the event detection circuit 170 outputs an event trigger signal EVTRG for triggering timestamp recording at the time of event occurrence. Specifically, the event detection circuit 170 generates a pulse of the event trigger signal EVTRG at the timing when the logic level of the event detection signal SEV changes. In the example of FIG. 2, the event detection circuit 170 generates a pulse of the event trigger signal EVTRG at both time tb and time tc.

The processing circuit 130 records, as condensation log information, the event detection signal SEV and the time information TMD when a pulse of the event trigger signal EVTRG is generated in the storage circuit 150. The logic level of the recorded event detection signal SEV indicates whether condensation has occurred or has dried at that time. In the example of FIG. 2, the processing circuit 130 records, at time tb, the event detection signal SEV at the low level associated with the time information TMD of time tb, and, at time tc, the event detection signal SEV at the high level in association with the time information TMD of time tc.

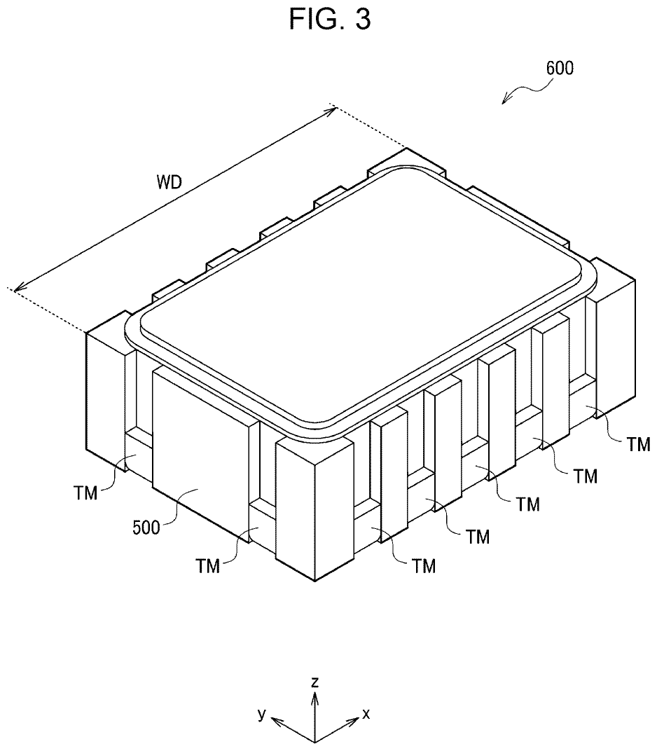

FIG. 3 is an external perspective view of the real-time clock device 600. The three mutually perpendicular directions are referred to as the x-direction, y-direction, and z-direction. The z-direction may also be referred to as the vertical direction.

The real-time clock device 600 includes a package 500, and has a structure in which a vibrator and an integrated circuit device are housed inside the package 500. The integrated circuit device includes the clock circuit 120, the event detection circuit 170, the storage circuit 150, and the processing circuit 130 described with reference to FIG. 1. The package 500 has a substantially rectangular parallelepiped shape, with its sides aligned along the x-, y-, and z-axes. A plurality of terminals TM for connecting the integrated circuit device housed in the package 500 to the outside of the package 500 are disposed on the bottom surface side of the package 500. FIG. 3 illustrates each terminal TM as having a shape that extends from the side surface to the bottom surface of the package 500; however, the shape of the terminal TM is not limited to this configuration. For example, the terminals TM may be bump terminals disposed on the bottom surface of the package 500, or lead terminals extending outward from the outer periphery of the bottom surface of the package 500.

The package 500 may be, for example, a ceramic package of the type used in oscillators with quartz crystal vibrators, sensors, or similar devices. Such a ceramic package may be regarded as a single component mounted on a printed circuit board or other substrate, and is much smaller than a typical electronic device in which multiple components are combined and housed together in a housing. For instance, the longest side of the package 500 has a length WD of 20 mm or less. Although FIG. 3 illustrates an example in which the x-direction side is the longest, the longest side may instead lie in the y- or z-direction. Accordingly, the real-time clock device 600 including the small-sized package 500 enables the implementation of a condensation logger that is significantly smaller than a large-scale dewpoint sensor disclosed in JP-A-2000-283938. The package 500 is not limited to a ceramic package and may instead be formed from other materials, such as resin. Additionally, although the real-time clock device 600 includes the terminals TM, it does not necessarily have to be mounted on a substrate, provided that power is supplied.

FIG. 4 illustrates a first structural example of the logger 40 using the real-time clock device 600 illustrated in FIG. 3. The logger 40 includes the real-time clock device 600, a battery 50, and a substrate 45. Various examples of the structure of the logger 40 are conceivable and will be described later.

The substrate 45 may be a rigid substrate such as a printed circuit board (PCB) or a ceramic substrate, or may be a flexible substrate. The substrate 45 has a hole HL1 and a hole HL2 extending through it between its first and second surfaces. The real-time clock device 600 and the battery 50 are mounted on the first surface of the substrate 45. The battery 50 may be a small-sized battery such as a button battery. The first electrode 41 and the second electrode 42 are disposed on the second surface of the substrate 45. The real-time clock device 600 includes a power supply terminal, a ground terminal, and an event input terminal as the terminals TM. The event input terminal is connected to the event detection circuit 170. The event input terminal and the first electrode 41 are connected by a wire LN1 via the hole HL1. The ground terminal, the negative terminal of the battery 50, and the second electrode 42 are connected by a wire LN2 via the hole HL2. The power supply terminal and the positive terminal of the battery 50 are connected by a wire LN3. The battery 50 may also be built into the real-time clock device 600.

As illustrated in the side view of FIG. 4, corrugated fiberboard 5a is assumed as the measurement object 5. The corrugated fiberboard 5a constitutes a corrugated fiberboard box for packaging an article during transportation. When the logger 40 is used, the logger 40 is attached to the corrugated fiberboard 5a such that the second surface of the substrate 45 is in contact with the inner wall surface of the corrugated fiberboard box. The second surface of the substrate 45 is attached to the corrugated fiberboard 5a with adhesive tape, an adhesive, or other means, so that the first electrode 41 and the second electrode 42 are in contact with the corrugated fiberboard 5a. When the corrugated fiberboard 5a is wetted by condensation, the real-time clock device 600 records the condensation event. The measurement object 5 is not limited to the corrugated fiberboard 5a and may be various objects as described above.

Although the logger 40 can be used for various purposes of detecting wetting by liquid, an exemplary usage of the logger 40 is physical distribution. In this case, the logger 40 is installed in or near an item to be transported, and is used to detect and record condensation during a physical distribution process. As used herein, the term “physical distribution process” includes not only transportation but also packaging and unpacking before and after transportation, as well as installation of the transported article. Additionally, the logger 40 may be used during one or more of packaging, transportation, unpacking, and installation.

Various attachment positions of the logger 40 in physical distribution are conceivable. For example, as described with reference to FIG. 4, the logger 40 may be attached to the inner wall of a corrugated fiberboard box as a packaging material. Alternatively, the logger 40 may be attached to the surface of an item to be packaged. Alternatively, the logger 40 may be incorporated in advance inside an item to be transported, such as being mounted on a substrate of an electronic device to be transported. Alternatively, the logger 40 may be attached inside the cargo compartment of a motor vehicle, train, ship, or aircraft used for transporting an item, or inside a container that stores the item during transportation.

Use of the logger 40 in physical distribution makes it possible to determine when condensation has occurred during the physical distribution process or when the condensation has dried. By comparing such log information with information indicating when each stage of the distribution is performed, it is possible to estimate at which stage the condensation event occurred. This enables investigation, assurance, certification or the like of transport quality.

For example, in recent years, paper has been increasingly used as a packaging material for environmental considerations. Paper is a useful alternative to resin as a packaging material; however, it has a disadvantage in that when wetted by condensation, its strength decreases, reducing its protective ability. Therefore, packaging design needs to include a margin against strength reduction caused by condensation, which may lead to increased transportation costs. The logger 40 of the present embodiment is small and inexpensive, and can therefore be readily used for transporting various items. This may guarantee the transport quality while reducing the amount of packaging material, resulting in lower transport costs. Additionally, transport quality can be assured by investigating the transport route using the logger 40 and improving the transport quality, which can also reduce packaging material use.

In addition, during physical distribution, condensation may occur not only on packaging materials but also on the items themselves. For example, it is assumed that items are contained in a corrugated fiberboard box. At night, the corrugated fiberboard box and the items cool down, and then during the day, the corrugated fiberboard box is warmed from the outside. In this process, the items remain cool while the surrounding air becomes warm, causing condensation on the items and wetting them. The logger 40 of the present embodiment is capable of recording the presence or absence of such condensation on items. For example, when an item vulnerable to moisture, such as an electronic device, is transported, the logger 40 may record the presence or absence of condensation to demonstrate that no condensation has occurred.

In the present embodiment, the logger 40 includes the clock circuit 120 configured to generate the time information TMD; the first electrode 41; the second electrode 42 to which the reference voltage VRF is supplied; the event detection circuit 170 configured to detect an event based on a voltage change of the input signal EV1 input from the first electrode 41; the storage circuit 150; and the processing circuit 130. The processing circuit 130 is configured to determine, in response to detection of the event by the event detection circuit 170, a change in a resistance value of the measurement object 5 between the first electrode 41 and the second electrode 42 due to wetting of the measurement object 5 by a liquid, and to record, in the storage circuit 150 as log information LGD, the time information TMD indicating detection of the event.

According to the present embodiment, the logger 40 can monitor that the resistance value of the measurement object 5 has changed due to wetting of the measurement object 5 by a liquid, and can detect a wetting event using the change in the resistance value and record log information of the wetting event. This enables detection of a liquid wetting state, rather than dew-point detection as described in JP-A-2000-283938. In addition, by using event detection based on a change in resistance value, the logger 40 having a simple configuration is implemented. For example, miniaturization, low power consumption, and low cost of the logger 40 are achieved.

Additionally, in the present embodiment, the first electrode 41 and the second electrode 42 are used in contact with the measurement object 5, or are disposed for the measurement object 5.

According to the present embodiment, when the measurement object 5 between the first electrode 41 and the second electrode 42 is wetted by a liquid, the resistance value between the first electrode 41 and the second electrode 42 changes. The event detection circuit 170 can detect an event based on a change in the voltage of the input signal EVI caused by the change in the resistance value.

Additionally, in the present embodiment, the event detection circuit 170 includes a pull-up resistor for pulling up the first electrode 41 or a pull-down resistor for pulling down the first electrode 41.

According to the present embodiment, the voltage of the input signal EVI is determined by the resistance ratio between the resistance value of the pull-up resistor or the pull-down resistor and the resistance value of the measurement object 5. When the measurement object 5 is wetted and the resistance value changes, the resistance ratio changes, thereby changing the voltage of the input signal EVI. The event detection circuit 170 can detect an event based on the voltage change of the input signal EVI.

Additionally, in the present embodiment, the logger 40 includes a real-time clock device 600 having the package 500. The package 500 houses the clock circuit 120, the event detection circuit 170, the storage circuit 150, and the processing circuit 130.

According to the present embodiment, the logger 40 is configured using the real-time clock device 600, enabling recording of a wetting event to be implemented using the timestamp function of the real-time clock device 600.

Additionally, in the present embodiment, the logger 40 includes the substrate 45 on which the first electrode 41 and the second electrode 42 are disposed. The first electrode 41 is connected to an event input terminal of the real-time clock device 600. The second electrode 42 is connected to a terminal of the reference voltage VRF of the real-time clock device 600. The terminal of the reference voltage VRF is, for example, a power supply terminal or a ground terminal, but may be a terminal of an arbitrary constant voltage.

According to the present embodiment, additionally, attaching the substrate 45 to the measurement object 5 or using the substrate 45 as the measurement object 5 enables an event to be detected based on the resistance value of the measurement object 5. Additionally, according to the present embodiment, the input signal EVI from the first electrode 41 is input to the event input terminal of the real-time clock device 600. Accordingly, a wetting event is recorded by the timestamp function of the real-time clock device 600.

Additionally, in the present embodiment, the real-time clock device 600 is disposed on the first surface of the substrate 45. The first electrode 41 and the second electrode 42 are disposed on the second surface of the substrate 45.

According to the present embodiment, since the second surface is in contact with the measurement object 5, the first surface on which the real-time clock device 600 is disposed is not in contact with the measurement object 5 that is likely to be wetted. This enables the real-time clock device 600 to be protected away from a liquid.

Additionally, in the present embodiment, the measurement object 5 may be paper.

When paper comes into contact with a liquid, it absorbs the liquid. Dry paper and wet paper have different resistances, and therefore use of such a difference enables detection of an event where paper is wetted by a liquid (hereafter referred to as a “liquid wetting event”). Additionally, paper is a material that is easily available or widely used in transportation and the like. Therefore, a highly convenient logger can be implemented by using paper.

Additionally, in the present embodiment, the measurement object 5 may be a packaging material.

According to the present embodiment, the logger 40 can record whether or not the packaging material is wetted by a liquid during the physical distribution process. Additionally, if the packaging material is wetted, the wetting time or the drying time can be recorded by the logger 40. This enables investigation, guarantee, certification or the like of the transport quality, enabling, for example, improvement in packaging design.

Additionally, in the present embodiment, the measurement object 5 may be the surface of a transported item.

According to the present embodiment, the logger 40 can record whether or not the surface of a transported item is wetted by a liquid during the physical distribution process. Additionally, if the surface is wetted, the wetting time or the drying time can be recorded by the logger 40. For example, there is a possibility that a transported item is wetted due to condensation or liquid leakage, although liquid wetting of the transported item is desired to be avoided. According to the present embodiment, it is possible to record whether such a transported object has not been wetted.

Additionally, the present embodiment may be implemented as a method for attaching the logger 40 to the measurement object 5. The logger 40 includes the clock circuit 120 that generates the time information TMD, the first electrode 41, the second electrode 42 to which the reference voltage VRF is supplied, the event detection circuit 170 that detects an event based on the input signal EVI input from the first electrode 41, the storage circuit 150, and the processing circuit 130. When the event detection circuit 170 detects an event, the processing circuit 130 records the time information TMD in the storage circuit 150. At this time, the attaching method is a method for attaching the logger 40 to the measurement object 5 such that the first electrode 41 and the second electrode 42 of the logger 40 are in contact with the measurement object 5.

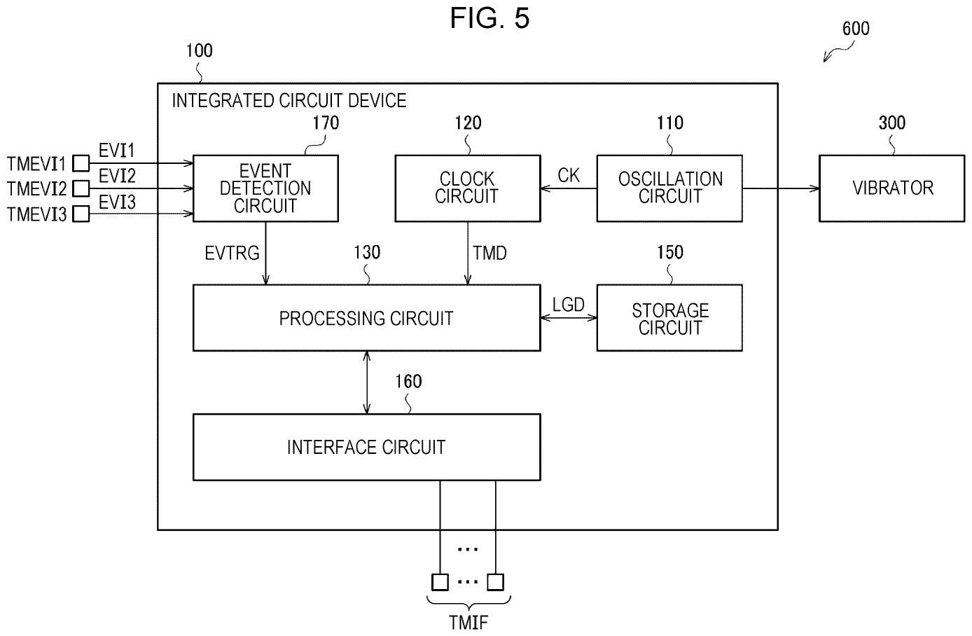

FIG. 5 is a block diagram illustrating a first circuit configuration example of the real-time clock device 600. The package 500 is omitted in the illustration. The real-time clock device 600 includes an integrated circuit device 100, a vibrator 300, interface terminals TMIF, and event input terminals TMEVI1 to TMEVI3. The interface terminals TMIF and the event input terminals TMEVI1 to TMEVI3 correspond to the terminals TM in FIG. 3.

The vibrator 300 is an element that generates mechanical vibrations in response to an electrical signal. The vibrator 300 may be implemented by a vibrator element such as a quartz crystal vibrator element. The vibrator 300 is, for example, a tuning fork type quartz crystal vibrator element. Alternatively, the vibrator 300 may be a quartz crystal vibrator element with a cut angle such as AT cut or SC cut, and performs thickness shear vibration. Other possibilities include vibrator elements of types other than the tuning-fork and thickness shear vibration types, and piezoelectric vibrator elements formed from materials other than quartz crystal. For example, the vibrator 300 may be a SAW resonator or a MEMS vibrator, which is a silicon vibrator formed using a silicon substrate. SAW stands for Surface Acoustic Wave, and MEMS stands for Micro Electro Mechanical Systems.

The integrated circuit device 100 includes an oscillation circuit 110, a clock circuit 120, a processing circuit 130, a storage circuit 150, an interface circuit 160, and an event detection circuit 170. For example, the integrated circuit device 100 is a semiconductor substrate in which a plurality of circuit elements are integrated.

The oscillation circuit 110 drives the vibrator 300 to cause the vibrator 300 to oscillate, and generates a clock signal CK based on the oscillating signal. A non-limiting example of the oscillation circuit 110 is a Colpitts oscillator.

The clock circuit 120 is a circuit that provides a clock function and generates time information TMD indicating the current time by counting based on the clock signal CK. The clock circuit 120 includes, for example, a frequency divider circuit that divides the frequency of the clock signal CK and a time counter that tracks the current time using the divided signal. The time information TMD may be, for example, the data of a count value from the time counter, or the calendar data described above.

Any of the event input terminals TMEVI1 to TMEVI3 is connected to the first electrodes 41 illustrated in FIG. 1 and other figures. The event detection circuit 170 outputs an event trigger signal EVTRG based on an input signal EVI1 from the event input node TMEVI1, an input signal EVI2 from the event input node TMEVI2, and an input signal EVI3 from the event input node TMEVI3. Specifically, the event detection circuit 170 generates an event detection signal from each of the input signals EVI1 to EVI3, and outputs a pulse of the event trigger signal EVTRG when the logic level of any one of the three event detection signals transitions.

When the pulse of the event trigger signal EVTRG is input, the processing circuit 130 associates the event occurrence information with the time information TMD and records the resulting information as the log information LGD in the storage circuit 150. The event occurrence information may be information of only the event detection signal whose logic level has transitioned, or may be information of all the event detection signals SEV1 to SEV3. The processing circuit 130 may include a control circuit. The control circuit may control some or all of the clock circuit 120, the oscillation circuit 110, the storage circuit 150, the interface circuit 160, and the event detection circuit 170. Control-related arrow lines are not illustrated in the drawings. The processing circuit 130 and the clock circuit 120 are logic circuits, and some or all of them may be implemented as an integrated logic circuit using automated place-and-route or the like.

The storage circuit 150 stores the log information LGD output from the processing circuit 130. The storage circuit 150 is a semiconductor memory and is a RAM or a nonvolatile memory. The RAM is, for example, SRAM or DRAM. SRAM stands for Static Random Access Memory, and DRAM stands for Dynamic Random Access Memory. The nonvolatile memory may be an electrically writable ROM, such as EEPROM. EEPROM stands for Electrically Erasable Programmable Read-Only Memory.

The interface circuit 160 communicates with the outside of the real-time clock device 600 via the interface terminals TMIF. The interface circuit 160 outputs the log information LGD stored in the storage circuit 150 to the outside. For example, in response to a read instruction from the outside, the interface circuit 160 reads the log information LGD from the storage circuit 150 and outputs it to the outside. Alternatively, the interface circuit 160 may output the log information LGD directly from the processing circuit 130 to the outside, without passing the log information LGD through the storage circuit 150. The interface circuit 160 may be an inter-circuit communication interface circuit that complies with any one of various standards. For example, the interface circuit 160 is a serial communication interface circuit in a Serial Peripheral Interface (SPI) mode or an Inter-Integrated Circuit (I2C) mode. SPI stands for Serial Peripheral Interface, and I2C stands for Inter-Integrated Circuit.

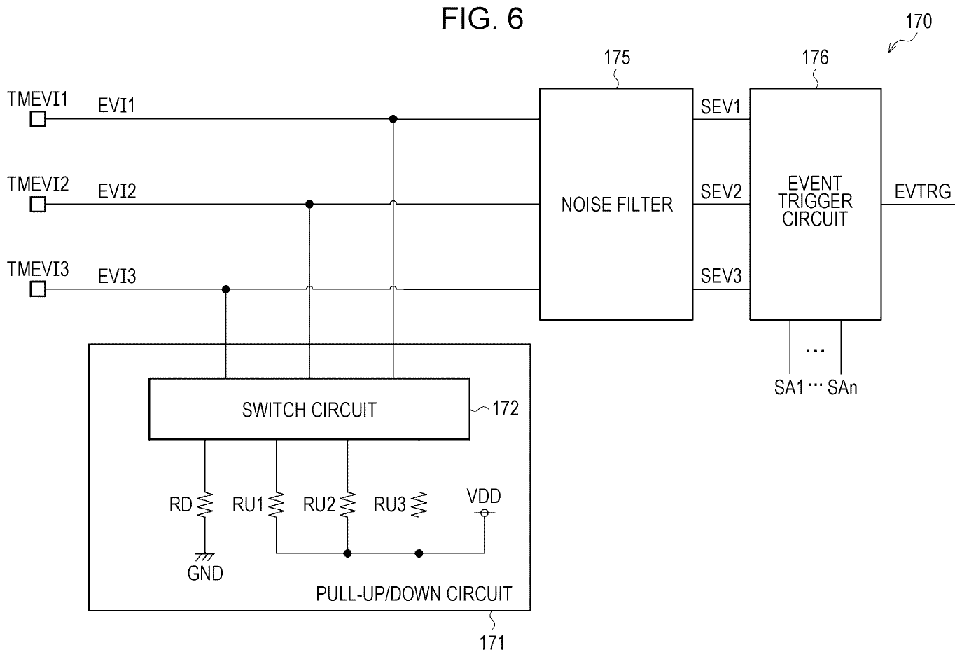

FIG. 6 is a block diagram illustrating a detailed configuration example of the event detection circuit 170. The event detection circuit 170 includes a pull-up/down circuit 171, a noise filter 175, and an event trigger circuit 176.

The pull-up/down circuit 171 includes a pull-down resistor RD, pull-up resistors RU1 to RU3, and a switch circuit 172. One end of the pull-down resistor RD is connected to a ground voltage node GND. One end of each of the pull-up resistors RU1 to RU3 is connected to a power supply voltage node VDD. The switch circuit 172 commonly connects the event input terminals TMEVI1 to TMEVI3 to the other end of any one of the pull-down resistor RD and the pull-up resistors RU1 to RU3. Alternatively, the switch circuit 172 may independently connect each of the event input terminals TMEVI1 to TMEVI3 to the other end of any one of the pull-down resistor RD and the pull-up resistors RU1 to RU3. The switch circuit 172 is, for example, an analog switch using a MOS transistor. The connection state of the switch circuit 172 may be set, for example, by register setting or the like. The resistance values of the pull-down and pull-up resistors may be selected as appropriate with respect to resistance value changes of the measurement object 5 caused by condensation. The number of pull-down resistors may be one or more, and the number of pull-up resistors may also be one or more. Additionally, the pull-up or the pull-down resistor may be disposed outside the real-time clock device 600. In such a case, the pull-up/down circuit 171 may be omitted.

The noise filter 175 compares the input signal EVI1 with a threshold voltage, performs binarization and filtering, and outputs the result as the event detection signal SEV1. Specifically, the noise filter 175 binarizes the input signal EVI1 into a low or high level using a comparator, a buffer circuit, or the like. The noise filter 175 samples the binarized signal, and when the same logic level continues for a predetermined number of sampling times, the noise filter 175 outputs the event detection signal SEV1 at that logic level. Similarly, the noise filter 175 compares the input signals EVI2 and EVI3 with the threshold voltage, performs binarization and filtering, and outputs the results as event detection signals SEV2 and SEV3.

When the logic level of any of the event detection signals SEV1 to SEV3 transitions, the event trigger circuit 176 outputs a pulse of the event trigger signal EVTRG. The event trigger circuit 176 may further output a pulse of the event trigger signal EVTRG when an event is detected based on other event inputs SA1 to SAn, where, n is an integer of 1 or more. The other event inputs SA1 to SAn may include, for example, a signal indicating an operating state of the real-time clock device 600. The event trigger circuit 176 may output a pulse of the event trigger signal EVTRG when the signal indicating the operating state changes or becomes a specific signal. Alternatively, the other event inputs SA1 to SAn may be commands input to the real-time clock device 600 from an external SoC or the like. In that case, the event trigger circuit 176 may output a pulse of the event trigger signal EVTRG when an arbitrary or specific command is input.

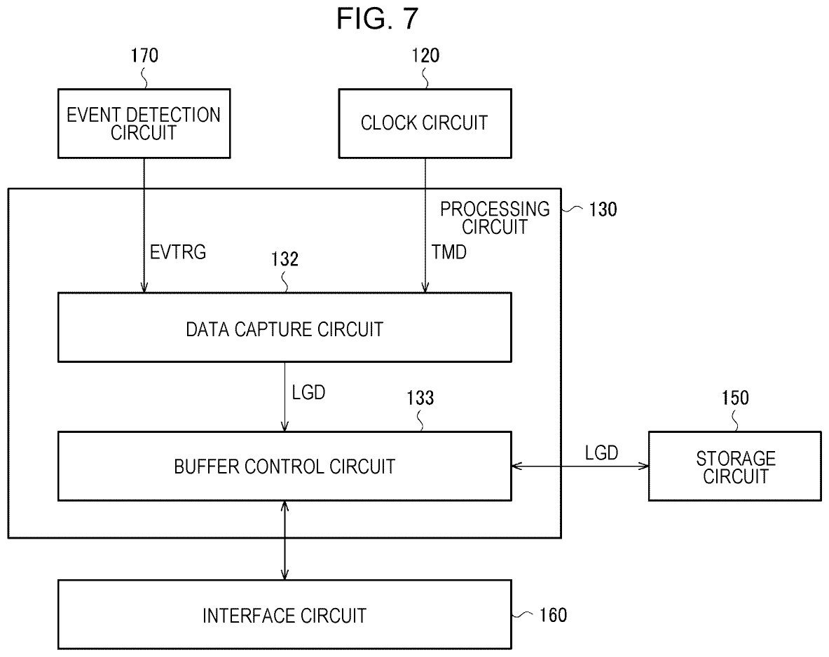

FIG. 7 is a block diagram illustrating a detailed configuration example of the processing circuit 130. The processing circuit 130 includes a data capture circuit 132 and a buffer control circuit 133.

When a pulse of the event trigger signal EVTRG is input, the data-capture circuit 132 outputs the event information and the time information TMD in association with each other as the log information LGD. The event information includes the event detection signals SEV1 to SEV3. The event information may further include other event inputs SA1 to SAn. The log information LGD is timestamp information of the RTC and may include timestamps of various events in addition to condensation events. For example, it is assumed that the event input terminal TMEVI1 is connected to the first electrode 41. In this case, the timestamp information output in response to a transition of the event detection signal SEV1 is the log information of a condensation event.

The buffer control circuit 133 records the log information LGD from the data capture circuit 132 in the storage circuit 150. When a read request is issued to the interface circuit 160 from an SoC or the like outside the real-time clock device 600, the buffer control circuit 133 reads the log information LGD from the storage circuit 150. The interface circuit 160 transmits the read log information LGD to the external SoC or the like.

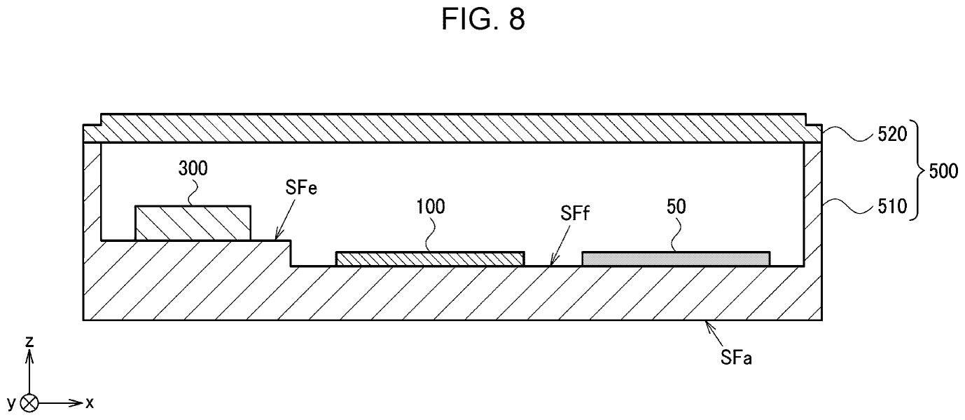

FIG. 8 illustrates a first structural example of the real-time clock device 600. FIG. 8 is a cross-sectional view when a cross section parallel to the xz plane is viewed in the +y direction. Hereafter, the terminal TM and the in-package wiring are omitted in the illustration. The +z direction may be referred to as up, and the-z direction may be referred to as down. Although FIG. 8 illustrates an example in which the real-time clock device 600 includes the battery 50, the battery 50 may alternatively be disposed outside the real-time clock device 600.

The package 500 includes a base 510 having a recess, and a lid 520, which is the lid of the base 510. The bottom surface SFa of the base 510 is parallel to the xy-plane, and the recess of the base 510 opens upward. The lid 520 covers the recess such that the edge of the lid 520 is bonded to the edge of the recess of the base 510, thereby sealing the integrated circuit device 100, the vibrator 300, and the battery 50 inside the package 500. The recess of the base 510 has a bottom surface SFf and a stepped surface SFe disposed above the bottom surface SFf. The integrated circuit device 100 and the battery 50 are arranged side by side in the x direction on the bottom surface SFf, and the vibrator 300 is arranged on the stepped surface SFe. The integrated circuit device 100 is, for example, a bare chip, and is disposed such that its thickness direction corresponds to the z direction.

The integrated circuit device 100 and the vibrator 300 are connected to each other by in-package wiring. The in-package wiring includes bonding wires or wiring disposed inside or on the inner surface of the structure of the base 510. For example, the integrated circuit device 100 includes a pad formed of the uppermost layer metal, and the vibrator 300 includes a terminal for wiring connection. The pad of the integrated circuit device 100 and the terminal of the vibrator 300 may be connected to each other by a bonding wire or may be temporarily connected to each other via the wiring of the base 510. In the latter case, the pad of the integrated circuit device 100 and the terminal of the vibrator 300 may be connected to the wiring of the base 510 using a bonding wire or a bump. Similarly, the integrated circuit device 100 and the battery 50 are connected to each other by in-package wiring.

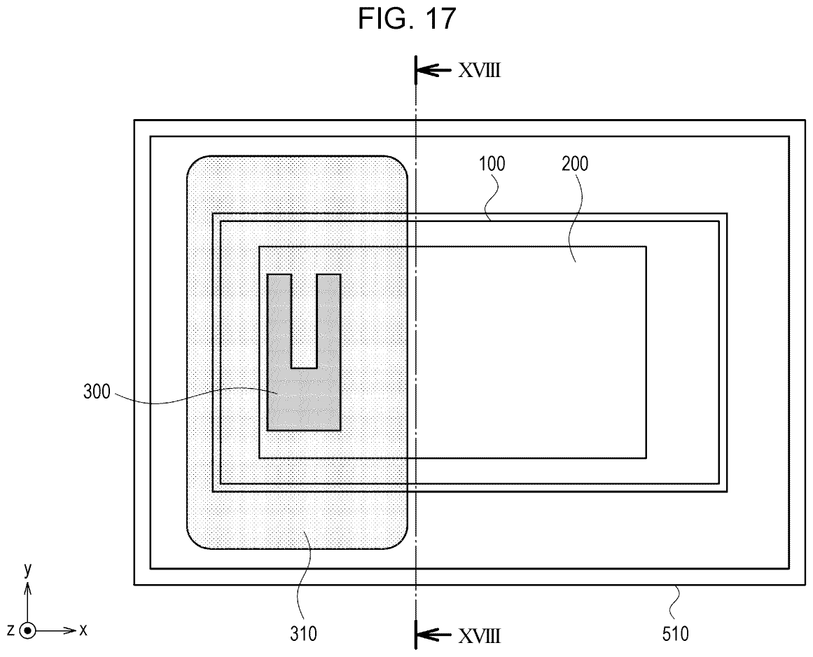

The battery 50 may be arranged on top of the integrated circuit device 100. In addition, as described later with reference to FIG. 17 and the like, the vibrator 300 may be disposed on a relay substrate or the like. In this case, the vibrator 300 and the integrated circuit device 100 may be arranged so as to overlap each other in plan view along the z direction.

In the present embodiment, the event detection circuit 170 includes the event trigger circuit 176. Hereafter, it is assumed, for example, that the event input terminal TMEVI1 is connected to the first electrode 41. The event trigger circuit 176 receives the input signal EVI1 from the event input terminal TMEVI1 and the other event inputs SA1 to SAn, and outputs the event trigger signal EVTRG. The processing circuit 130 records the timestamp information based on the event trigger signal EVTRG as the log information LGD.

The real-time clock device 600 has a function of recording timestamp information when various events occur. In the present embodiment, a liquid wetting event is detected as one of the events. Accordingly, the configuration of the logger 40 can be simplified by detecting a liquid wetting event using the timestamp function of the real-time clock device 600.

### 2. Other Configuration Examples

FIG. 9 illustrates a second structural example of the logger 40. This example is basically the same as the first side view and the second side view of FIG. 4; however, the logger 40 further includes the piece of paper 56, which is the measurement object 5. The piece of paper 56 is attached to the substrate 45 so as to be in contact with the first electrode 41 and the second electrode 42. The piece of paper 56 is attached to the substrate 45 by, for example, an adhesive tape or an adhesive. In this example, the logger 40 can be used without being attached to a corrugated fiberboard box or the like.

FIG. 10 illustrates a third structural example of the logger 40. In this example, the real-time clock device 600 itself is the logger 40. The battery 50 is built into the real-time clock device 600. As described with reference to FIG. 3, a plurality of terminals TM are disposed on the back surface of the real-time clock device 600. Among them, the event input terminal TMEVI is used as the first electrode 41, and the ground terminal TMGND is used as the second electrode 42. As illustrated in the side view of FIG. 10, the real-time clock device 600 is attached to the corrugated fiberboard 5a such that its back surface is in contact with the corrugated fiberboard 5a. As a result, the event input terminals TMEVI, which are the first electrodes 41, and the ground terminals TMGND, which are the second electrodes 42, come into contact with the corrugated fiberboard 5a. The attachment is, for example, achieved by using an adhesive tape or an adhesive. The measurement object 5 is not limited to the corrugated fiberboard 5a.

FIG. 11 illustrates a fourth structural example of the logger 40. The logger 40 includes the real-time clock device 600, the substrate 46, a first electric wire 47, and a second electric wire 48. The real-time clock device 600 has a built-in battery and is not mounted on a substrate. Alternatively, a battery may be disposed outside the real-time clock device 600, and the real-time clock device 600 and the battery may be mounted on a substrate. The substrate 46 has a first surface and a second surface, and the substrate 46 is attached to the corrugated fiberboard 5a such that the second surface is in contact with the corrugated fiberboard 5a. On the second surface, the first electrode 41 and the second electrode 42 are disposed in the same manner as on the second surface of the substrate 45 illustrated in FIG. 4. One end of the first electric wire 47 is connected to the event input terminal of the real-time clock device 600, and the other end is connected to the first electrode 41 of the substrate 46. One end of the second electric wire 48 is connected to the ground terminal TMGND of the real-time clock device 600, and the other end is connected to the second electrode 42 of the substrate 46. The measurement object 5 is not limited to the corrugated fiberboard 5a.

FIG. 12 illustrates a fifth structural example of the logger 40. This example is basically the same as the fourth structural example of FIG. 11; however, the real-time clock device 600 is mounted on the substrate 11 inside an electronic device 10. Additionally, the second surface of the substrate 46 is attached to the inner surface of the housing 5c of the electronic device 10. The measurement object 5 is the housing 5c, and the housing 5c is, for example, resin or metal coated with an insulating film. Various components, such as an integrated circuit (IC), a resistor, a capacitor, or a connector for implementing the functions of the electronic device 10 may be mounted on the substrate 11. Examples of the electronic device 10 vary but include a printer, projector, television set, camera, personal computer, display, game console, smartphone, smartwatch, head-mounted display, or audio equipment.

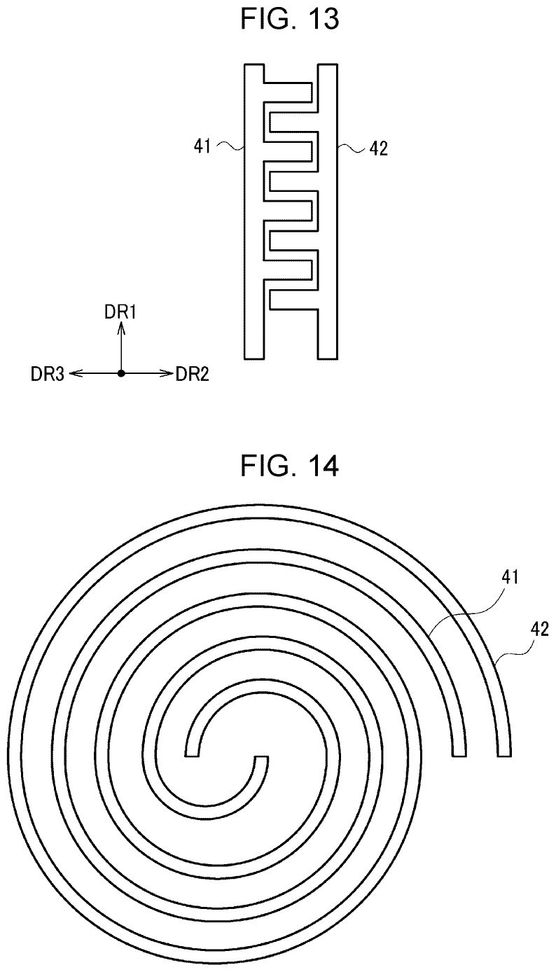

FIG. 13 depicts a second shape example of the first electrode 41 and the second electrode 42. The first shape example is two parallel linear electrodes as illustrated in, for example, FIG. 4. In FIG. 13, any two directions perpendicular to each other are referred to as a first direction DR1 and a second direction DR2. The direction opposite to the second direction DR2 is referred to as a third direction DR3. In the second shape example, the first electrode 41 includes a linear portion extending along the first direction DR1 and a comb-tooth portion protruding in the second direction DR2 from the linear portion. The second electrode 42 includes a linear portion along the first direction DR1 and a comb-tooth portion protruding in the third direction DR3 from the linear portion. The comb-tooth portion of the first electrode 41 and the comb tooth portion of the second electrode 42 are disposed so as to mesh with each other. That is, the teeth of the comb-tooth portion of the first electrode 41 and the teeth of the comb-tooth portion of the second electrode 42 are alternately arranged along the first direction.

FIG. 14 depicts a third shape example of the first electrode 41 and the second electrode 42. Each of the first electrode 41 and the second electrode 42 has a spiral shape. The spiral of the first electrode 41 and the spiral of the second electrode 42 are arranged such that the first electrode 41 and the second electrode 42 appear alternately on a straight line connecting the center of the spirals and an arbitrary outside point.

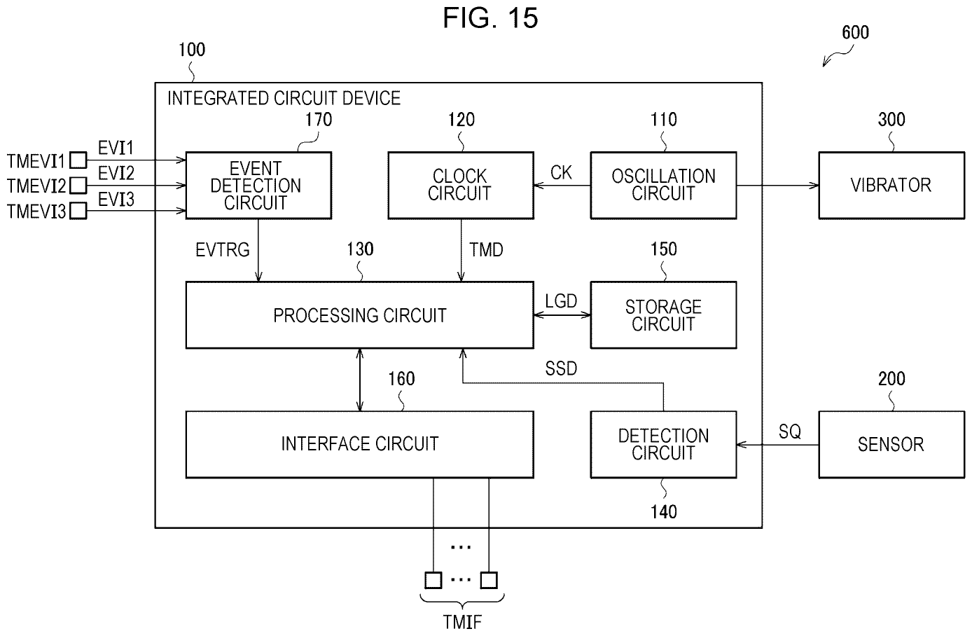

FIG. 15 is a block diagram illustrating a second circuit configuration example of the real-time clock device 600. The description of the same portions as those of the first circuit configuration example of FIG. 5 will be omitted. The real-time clock device 600 further includes a sensor 200. The integrated circuit device 100 further includes a detection circuit 140.

The sensor 200 detects environmental information and outputs an output signal SQ as the detection result. Specific examples of the sensor 200 will be described later. Although FIG. 15 illustrates an example in which the real-time clock device 600 includes one sensor, the real-time clock device 600 may include a plurality of sensors.

The detection circuit 140 performs detection processing on the output signal SQ from the sensor 200 and outputs sensor detection information SSD as the result. The output signal SQ is, for example, a charge, current, voltage, or other analog signal. The sensor detection information SSD may be digital data suitable for handling by a logic circuit in a subsequent stage. The digital data is not limited to multi-bit data and includes binary (1-bit) signals. For example, the detection circuit 140 may include an analog-to-digital (A/D) conversion circuit. The A/D conversion circuit converts the output signal SQ from analog to digital and outputs the resulting sensor detection information SSD. Alternatively, the detection circuit 140 may further include an amplifier circuit that amplifies the output signal SQ prior to A/D conversion. If the output signal SQ includes a carrier wave signal and a detection signal, the detection circuit 140 may further include a demodulator to extract the detection signal from the output signal SQ prior to the A/D conversion circuit. In the case where the sensor detection information SSD is binary output, the detection circuit 140 may include a comparator that compares the output signal SQ to a reference voltage corresponding to a threshold.

The processing circuit 130 associates output environmental information, based on the sensor detection information SSD, with the time information TMD, and outputs the resulting information as log information LGD. The output environmental information may be the sensor detection information SSD itself or may be information derived by performing operations on the sensor detection information SSD. These operations may include, for example, addition, subtraction, multiplication, division, differentiation, integration, or statistical processing. The processing circuit 130 may always output the log information LGD, or may output the output environmental information and the time information TMD as the log information LGD when an event of the environment information is detected. Alternatively, when a condensation event is detected, the processing circuit 130 may output the condensation event information, the output environmental information, and the time information TMD as the log information LGD.

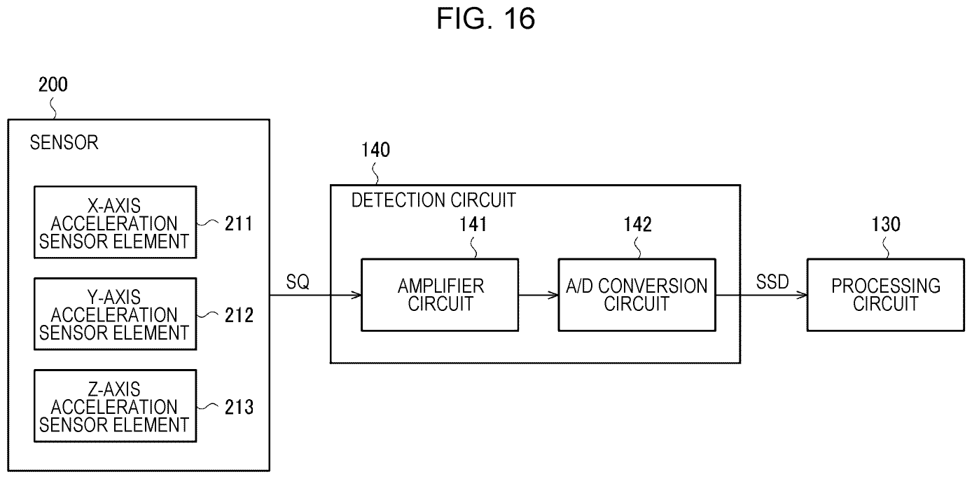

A detailed configuration example and an operation example of the case where the sensor 200 is a MEMS acceleration sensor will be described hereafter. In this example, for example, an impact or acceleration applied to a transportation object is detected as the environmental information. That is, the logger 40 in this example is both a condensation logger and a shock data logger. An example in which the sensor 200 is another sensor will be described later. FIG. 16 is a block diagram illustrating a detailed configuration example of the sensor 200 and the detection circuit 140.

The sensor 200 includes an x-axis acceleration sensor element 211, a y-axis acceleration sensor element 212, and a z-axis acceleration sensor element 213. Although the example in which the sensor 200 is a three-axis acceleration sensor is illustrated here, the sensor 200 may be a one-axis or two-axis acceleration sensor. The sensor 200 has a substantially plate-like shape parallel to the xy-plane. In a specific example, the sensor 200 includes a support substrate having a bottom surface parallel to the xy-plane and a lid bonded to the support substrate. The x-axis acceleration sensor element 211, the y-axis acceleration sensor element 212, and the z-axis acceleration sensor element 213 are arranged on a support substrate and are covered with the lid.

The x-axis acceleration sensor element 211 includes a comb-shaped fixed electrode fixed to the support substrate, a movable portion configured to be movable with respect to the support substrate, and a comb-shaped movable electrode fixed to the movable portion. The comb teeth of the fixed electrode and the comb teeth of the movable electrode are arranged to face each other in the x-direction. When acceleration in the x-direction is applied to the x-axis acceleration sensor element 211, the movable portion moves in the x-direction and the distance between the comb teeth changes, so that the capacitance between the comb teeth changes. By detecting the change in the capacitance, the detection circuit 140 detects the acceleration in the x-direction as the sensor detection information SSD. The y-axis acceleration sensor element 212 has the same configuration.

The z-axis acceleration sensor element 213 includes a comb-shaped fixed electrode fixed to the support substrate, a movable portion capable of swinging about a rotation shaft parallel to the xy-plane, and a comb-shaped movable electrode fixed to the movable portion. The comb teeth of the fixed electrode and the comb teeth of the movable electrode are arranged to face each other in the x-direction or the y-direction. When acceleration in the z-direction is applied, the movable portion swings and the overlapping area between the comb teeth changes, so that the capacitance between the comb teeth changes. By detecting the change in the capacitance, the detection circuit 140 detects the acceleration in the z-direction as the sensor detection information SSD.

The detection circuit 140 includes an amplifier circuit 141 and an A/D conversion circuit 142. The amplifier circuit 141 and the A/D conversion circuit 142 may be provided for each of the x-axis acceleration sensor element 211, the y-axis acceleration sensor element 212, and the z-axis acceleration sensor element 213. Alternatively, the detection circuit 140 may include a selector, and the selector may select the output signals of the x-axis acceleration sensor element 211, the y-axis acceleration sensor element 212, and the z-axis acceleration sensor element 213 in a time-division manner and output the selected output signals to the amplifier circuit 141.

The detection circuit 140 includes the amplifier circuit 141 and the A/D conversion circuit 142. Here, it is assumed that SQ represents the output signal of the x-axis acceleration sensor element 211, but the same applies to the output signals of the y-axis acceleration sensor element 212 and the z-axis acceleration sensor element 213.

The amplifier circuit 141 converts the output signal SQ of the x-axis acceleration sensor element 211 from a charge (C) signal to a voltage (V) signal (Q/V conversion) and amplifies the voltage signal. The A/D conversion circuit 142 converts the output signal of the amplifier circuit 141 from analog to digital (A/D conversion) and outputs a result of the A/D conversion, which is x-axis acceleration data, as the sensor detection information SSD.

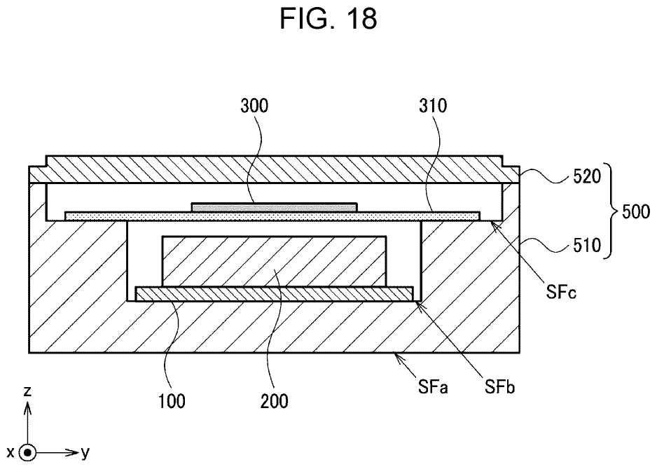

FIGS. 17 and 18 illustrates the second structural example of the real-time clock device 600. FIG. 17 is a plan view of the real-time clock device 600 when viewed along the −z direction, and FIG. 18 is a cross-sectional view taken along line XVIII-XVIII of FIG. 17. Hereafter, the terminal TM and the in-package wiring are omitted in the illustration. Additionally, in the plan view, a lid 520 of the package 500 is omitted in the illustration. Additionally, the +z direction may be referred to as up, and the-z direction may be referred to as down.

The recess of the base 510 has a bottom surface SFb and a step surface SFc disposed above the bottom surface SFb. The integrated circuit device 100 is disposed on the bottom surface SFb, and the sensor 200 is disposed on top of the integrated circuit device 100. The sensor 200 is, for example, a substantially rectangular parallelepiped. The integrated circuit device 100 and the sensor 200 are arranged such that their thickness directions correspond to the z direction. The vibrator 300 is, for example, a quartz crystal vibrator and is formed on a quartz crystal relay substrate 310. With an end portion of the relay substrate 310 bonded to the stepped surface SFc, the vibrator 300 is housed in the base 510. Then, the lid 520 covers the recess of the base 510 such that the edge of the lid 520 is bonded onto the edge of the recess, thereby sealing the integrated circuit device 100, the sensor 200, and the vibrator 300 in the package 500. FIGS. 17 and 18 illustrate an example in which the relay substrate 310 is disposed in the-x direction with respect to the center of the base 510 and three sides of the relay substrate 310 are bonded onto the stepped surface SFc. In plan view, the vibrator 300 may overlap the integrated circuit device 100 and the sensor 200 or may overlap only the integrated circuit device 100.

The integrated circuit device 100 and the sensor 200 are connected to each other by in-package wiring. The integrated circuit device 100 and the vibrator 300 are connected to each other by in-package wiring. The in-package wiring is as described with reference to FIG. 8.

The sensor 200 that detects the environmental information is not limited to the MEMS acceleration sensor described above. The environmental information may be, for example, impact, acceleration, angular velocity, temperature, dew point, humidity, odors, gases, forces, or pressure. The real-time clock device 600 detects one or more of these parameters. Examples of the sensor 200 are as follows.

(1) Acceleration sensor: The sensor 200 is, for example, a capacitive acceleration sensor using silicon MEMS described above. Alternatively, the sensor 200 may be an acceleration sensor using a quartz crystal vibrator, an acceleration sensor using a piezoelectric element, or other type. The logger 40 equipped with the acceleration sensor can be used as, for example, a shock data logger. That is, by using the acceleration sensor, the logger 40 detects and records the impact applied to a device equipped with the logger 40 as the environmental information.

(2) Temperature sensor: The sensor 200 is, for example, a thermistor, thermocouple, or resistance temperature detector. Alternatively, the sensor 200 may be a temperature sensor that measures temperature using the temperature characteristics of the forward voltage of a p-n junction. Such a temperature sensor may be built in the integrated circuit device 100. The integrated circuit device 100 may include, for example, a temperature sensor and a temperature compensation circuit that performs the temperature compensation of the oscillation frequency of the oscillation circuit 110 based on a detection signal of the temperature sensor. The temperature sensor used for the temperature compensation may also serve as the sensor 200.

(3) Odor sensor: The sensor 200 is, for example, a gas sensor that senses odors by detecting gases in the air.

(4) Force sensor: The sensor 200 is, for example, a load sensor using a quartz crystal vibrator. The sensor 200 includes a quartz crystal double-ended tuning fork (DETF) vibrator and a cantilever. When a force is applied to the cantilever, the tension on the quartz crystal DETF vibrator changes. The change in tension causes a shift in the vibration frequency of the quartz crystal DETF vibrator. This frequency shift enables the detection of the applied force. Alternatively, the sensor 200 may be a force or pressure sensor using silicon MEMS technology.

(5) Angular velocity sensor: The sensor 200 may be a gyro sensor using a quartz crystal vibrator or a MEMS vibrator. For example, the quartz crystal vibrator includes driving arms and sensing arms, and a drive circuit drives the driving arms to vibrate the driving arms. When the Coriolis force is generated due to the angular velocity, the vibration states of the sensing arms change. By detecting the changes, the angular velocity can be detected. This quartz crystal vibrator may also serve as the vibrator 300 for generating the clock signal CK. In this case, the drive circuit that drives the driving arms corresponds to the oscillation circuit 110.

The environmental information is detected by using the sensor 200 as described above, and is recorded together with the time information TMD by the clock circuit 120, enabling an environmental data logger in a physical distribution process to be configured. By recording the time information TMD, for example, the time at which a specific event has occurred can be known later. By collating such log information with information indicating the time at which each stage of the physical distribution is performed, it is possible to estimate at which stage of the physical distribution a specific event has occurred.

As described with reference to FIG. 10, the first electrodes 41 may be the event input terminal TMEVI of the real-time clock device 600. The second electrode 42 may be a reference voltage terminal of the real-time clock device 600. In the example of FIG. 10, the reference voltage terminal is the ground terminal TMGND.

According to the present embodiment, a liquid wetting event can be detected by using the real-time clock device 600 itself as the logger 40. The real-time clock device 600 is a very small device sealed in a ceramic package or the like. According to the present embodiment, a very small logger 40 can be implemented by using the real-time clock device 600 in such a manner.

Additionally, as described with reference to FIGS. 10 and 8, the logger 40 may include the battery 50 housed in the package 500 of the real-time clock device 600.

According to the present embodiment, the real-time clock device 600 can be operated by the built-in battery 50, enabling the real-time clock device 600 itself to be used as the logger 40.

Additionally, as described with reference to FIGS. 11 and 12, the logger 40 may include the substrate 46, the first electric wire 47, and the second electric wire 48. The first electrode 41 and the second electrode 42 may be disposed on the substrate 46. The first electric wire 47 may connect the first electrode 41 to an event input terminal of the real-time clock device 600. The second electric wire 48 may connect the second electrode 42 and the reference voltage terminal of the real-time clock device 600. The reference voltage terminal is, for example, a ground terminal.

According to the present embodiment, the real-time clock device 600 can be disposed separate from the first electrode 41 and the second electrode 42 that are in contact with the measurement object 5, which is likely to be wetted. Thus, the real-time clock device 600 can be protected away from a liquid.

Additionally, as described with reference to FIG. 9, the logger 40 may include the measurement object 5.

According to the present embodiment, since the logger 40 includes the measurement object 5 in advance, the logger 40 can be used without being attached to the measurement object 5.

Additionally, as described with reference to FIGS. 15 to 18, the logger 40 may include an acceleration sensor. The processing circuit 130 may record impact log information based on acceleration data from the acceleration sensor in the storage circuit 150.

According to the present embodiment, in addition to a liquid wetting event, the impact information can be recorded in association with the time information TMD as the log information LGD. By referring to the log information LGD, it is possible to know when an impact is applied to a device equipped with the logger 40 or when and what kind of impact is applied to the device equipped with the logger 40.

Additionally, in the present embodiment, the logger 40 may include a temperature sensor. The processing circuit 130 may record temperature log information based on temperature detection data from the temperature sensor in the storage circuit 150.

According to the present embodiment, in addition to a liquid wetting event, the temperature information can be recorded in association with the time information TMD as the log information LGD. By referring to the log information LGD, it is possible to know the environmental temperature at each time, when a change or the like in the environmental temperature has occurred, or the like.

Although the present embodiment is described in detail as described above, those skilled in the art could easily understand that many modifications may be made without substantially departing from new matters and effects of the present disclosure. Therefore, all such modifications are included in the scope of the present disclosure. For example, the terms described together with different terms having a broader meaning or the same meaning at least once in the specification or the drawings may be replaced with the different terms in any portion in the specification or the drawings. In addition, all combinations of the present embodiment and modifications are also included in the scope of the present disclosure. In addition, the configurations, operations, and the like of the clock circuit, the event detection circuit, the storage circuit, the processing circuit, the oscillation circuit, the interface circuit, the detection circuit, the integrated circuit device, the vibrator, the sensor, the package, the real-time clock device, the first electrode, the second electrode, the substrate, the logger, the measurement object, and the like are not limited to those described in the present embodiment, and various modifications can be made.

What is claimed is:

1. A logger comprising:
a clock circuit configured to generate time information;
a first electrode;
a second electrode to which a reference voltage is supplied;
an event detection circuit configured to detect an event based on a voltage change of an input signal input from the first electrode;
a storage circuit; and
a processing circuit configured to determine, in response to detection of the event by the event detection circuit, a change in a resistance value of the measurement object disposed between the first electrode and the second electrode due to wetting of the measurement object by a liquid, and to record, in the storage circuit as log information, the time information indicating detection of the event.

2. The logger according to claim 1, wherein the first electrode and the second electrode are used while being in contact with the measurement object or are disposed for the measurement object.

3. The logger according to claim 1, wherein the event detection circuit includes a pull-up resistor configured to pull up the first electrode or a pull-down resistor configured to pull down the first electrode.

4. The logger according to claim 1, further comprising a real-time clock device including a package that houses the clock circuit, the event detection circuit, the storage circuit, and the processing circuit.

5. The logger according to claim 4, wherein
the event detection circuit includes an event trigger circuit configured to receive the input signal and another event input and to output an event trigger signal, and
the processing circuit is configured to record, as the log information, timestamp information based on the event trigger signal.

6. The logger according to claim 4, further comprising a substrate on which the first electrode and the second electrode are disposed, wherein
the first electrode is connected to an event input terminal of the real-time clock device, and
the second electrode is connected to a terminal of the reference voltage of the real-time clock device.

7. The logger according to claim 6, wherein
the real-time clock device is disposed on a first surface of the substrate, and
the first electrode and the second electrode are disposed on a second surface of the substrate.

8. The logger according to claim 4, wherein
the first electrode is an event input terminal of the real-time clock device, and
the second electrode is a terminal of the reference voltage of the real-time clock device.

9. The logger according to claim 8, further comprising a battery housed in the package of the real-time clock device.

10. The logger according to claim 4, further comprising:
a substrate on which the first electrode and the second electrode are disposed;
a first electric wire connecting the first electrode and an event input terminal of the real-time clock device; and
a second electric wire connecting the second electrode and a terminal of the reference voltage of the real-time clock device.

11. The logger according to claim 1, further comprising the measurement object.

12. The method according to claim 1, wherein the measurement object is paper.

13. The logger according to claim 1, wherein the measurement object is a packaging material.

14. The logger according to claim 1, wherein the measurement object is a surface of a transported object.

15. The logger according to claim 1, further comprising an acceleration sensor, wherein
the processing circuit is configured to record, in the storage circuit, impact log information based on acceleration data from the acceleration sensor.

16. The logger according to claim 1, further comprising a temperature sensor, wherein
the processing circuit is configured to record, in the storage circuit, temperature log information based on temperature detection data from the temperature sensor.

17. A method for attaching a logger to a measurement object, the logger including
a clock circuit configured to generate time information,
a first electrode,
a second electrode to which a reference voltage is supplied,
an event detection circuit configured to detect an event based on an input signal input from the first electrode,
a storage circuit, and
a processing circuit configured to record the time information in the storage circuit when the event detection circuit detects the event,
the method comprising:
attaching the logger to the measurement object such that the first electrode and the second electrode of the logger are in contact with the measurement object.
